(19) United States
(12) Patent Application Publication
(10) Pub. No.: US 2006/0207879 A1
(43) Pub. Date: Sep. 21, 2006

(54) Sensor element

(76) Inventors: Hans-Martin Wiedenmann, Stuttgart (DE); Lothar Diehl, Gerlingen (DE); Thomas Moser, Schwieberdingen (DE); Stefan Rodewald, Ditzingen (DE)

Correspondence Address: KENYON & KENYON LLP, ONE BROADWAY, NEW YORK, NY, 10004, US

(21) Appl. No.: 10/540,331

(22) PCT Filed: Dec. 12, 2003
(86) PCT No.: PCT/DE03/04110

§ 371 Date: Apr. 13, 2006

(30) Foreign Application Priority Data
Dec. 19, 2002 (DE) 102 59 526.7

(51) Int. Cl. G01N 27/26

(52) U.S. Cl. 204/424

(57) ABSTRACT

A sensor element which is used for determining a property of a measuring gas, e.g., for determining the concentration of a gas component in the measuring gas, has at least one electrode applied to one solid electrolyte, the electrode being in contact with the measuring gas via a diffusion path in which a diffusion barrier is situated. A means is provided in the region of the side of the diffusion barrier facing away from the electrode, the means reducing the diffusion cross section in the region of the side of the diffusion barrier facing away from the electrode.

### FIELD OF THE INVENTION

The present invention is directed to a sensor element.

### BACKGROUND INFORMATION

Such a sensor element is known from German Published Patent Application No. 100 13 882, for example. The sensor element is configured in layers using planar technology and contains a measuring gas cavity in which two annular electrodes are situated on opposite sides. The two electrodes are each part of an electrochemical cell including another electrode as well as a solid electrolyte situated between the electrodes. The two electrodes situated in the measuring gas cavity are in contact with a measuring gas, located outside of the sensor element, via a hollow cylinder-shaped diffusion barrier and a gas entry opening. The gas entry opening opens into the center of the diffusion barrier. One of the two electrochemical cells is operated as a Nernst cell in which a voltage (Nernst voltage) which is a measure of the relationship of the oxygen partial pressure at the electrode in the measuring gas cavity and the electrode exposed to the reference gas is formed between the electrode in the measuring gas cavity and an electrode exposed to a reference gas.

The diffusion barrier is subdivided into a coarse-porous section and a fine-porous section. The coarse-porous section has a catalytically active material for adjusting the balance in the gas mixture.

During a sudden pressure increase in the measuring gas, known as a pressure pulse, the pressure in the measuring gas cavity also rises. If the measuring gas composition is otherwise the same, the pressure pulse causes a rise in the oxygen partial pressure at the electrodes in the measuring gas cavity and thus also a rise in the Nernst voltage. If the measuring gas composition is the same, in particular if the oxygen content is the same, the sensor element thus responds to a change in the oxygen partial pressure. However, it is desired that the sensor element's measuring signal reflects the oxygen content of the measuring gas, i.e., the percentage of oxygen in the measuring gas, and not the changes in the oxygen partial pressure contingent on pressure fluctuations.

### SUMMARY OF THE INVENTION

The sensor element according to the present invention has the advantage over the related art that, given otherwise the same measuring gas composition, the dependence of the sensor element's measuring signal on pressure fluctuations is reduced.

The sensor element has an electrode which is in contact with the measuring gas via a diffusion path in which a diffusion barrier is situated. The measuring gas travels along the diffusion path and reaches the electrode through the diffusion barrier. The diffusion flow of the oxygen through the diffusion barrier up to the electrode depends on the design of the diffusion barrier.

A sudden measuring gas pressure increase is represented by a pressure pulse which spreads out along the diffusion path through the diffusion barrier up to the electrode. On the side facing away from the electrode, the measuring gas has a comparatively high velocity which is reduced during the passage through the diffusion barrier up to the electrode. A reduction in the velocity of the pressure pulse dampens sudden pressure fluctuations on the way to the electrode so that the pressure pulse's influence on the measuring signal is reduced.

It has been found that the pressure pulses are reduced most effectively in a region in which the measuring gas has a high gas velocity. Therefore, a means is provided in the region of the diffusion barrier facing away from the electrode to reduce the diffusion cross section in this region facing away from the electrode.

Here and in the following, the diffusion cross section is understood to be the open surface perpendicular to the diffusion direction. The open surface is the surface through which the measuring gas is able to pass. In the case of a porous diffusion barrier, the open surface is the surface which is occupied by the pores in a two-dimensional section.

The diffusion cross section refers to a surface perpendicular to the diffusion direction. In a hollow cylinder-shaped diffusion barrier, in which the measuring gas and the oxygen, respectively, diffuse from the inner lateral surface to the outer lateral surface, the flow direction from the inner lateral surface is directed radially outward. Therefore, the diffusion cross section refers to surfaces at a constant distance from the center line of the hollow cylinder-shaped diffusion barrier.

The means for reducing the diffusion cross section is preferably gas-impermeable or has a lower pore proportion than the diffusion barrier.

The diffusion barrier has particularly advantageously an essentially cylindrical or hollow-cylindrical shape and is surrounded by an annular electrode. The measuring gas reaches the electrode via a gas entry opening and through the diffusion barrier. Due to the geometry, the diffusion cross section increases linearly with respect to the distance to the center line of the diffusion barrier. This cross section increase causes additional dampening of the pressure pulse. The means for reducing the diffusion cross section in the region of the side of the diffusion barrier facing away from the electrode is preferably designed in such a way that

$$\frac{{A}_{1}}{{r}_{1}} > \frac{{A}_{2}}{{r}_{2}}$$

radii r₁ and r₂ being related to the center line of the diffusion barrier, A₁ indicating the diffusion cross section at distance r₁ from the center line of the diffusion barrier and A₂ indicating the diffusion cross section at distance r₂ from the center line of the diffusion barrier, the means reducing the diffusion cross section lying at distance r₂, but not distance r₁, from the center line of the diffusion barrier, and r₁ being greater than r₂. The means for increasing the diffusion resistance is thus designed in such a way that the diffusion cross section in the region of the diffusion barrier increases more than linearly with respect to the distance to the center line.

In a preferred exemplary embodiment, the means is an annular element which is provided in the region of the inner lateral surface of the diffusion barrier and/or in the region of the gas entry opening. In an alternative exemplary embodiment, the means is/are one or multiple arrow-like element(s) which is/are provided in the region of the inner lateral surface of the diffusion barrier and/or in the region of the gas entry opening and whose height corresponds to the height of the diffusion barrier.

### BRIEF DESCRIPTION OF THE DRAWINGS

FIG. 1 shows the first exemplary embodiment of the invention in a longitudinal cross-sectional view taken along line I-I in FIG. 2.

FIG. 2 shows a section of the first exemplary embodiment taken along line II-II in FIG. 1.

FIG. 3 shows the second exemplary embodiment of the present invention in a cross-sectional view of a section perpendicular to the longitudinal axis of the sensor element, taken along line III-III in FIG. 4.

FIG. 4 shows a section of the second exemplary embodiment taken along line IV-IV in FIG. 3.

### DETAILED DESCRIPTION

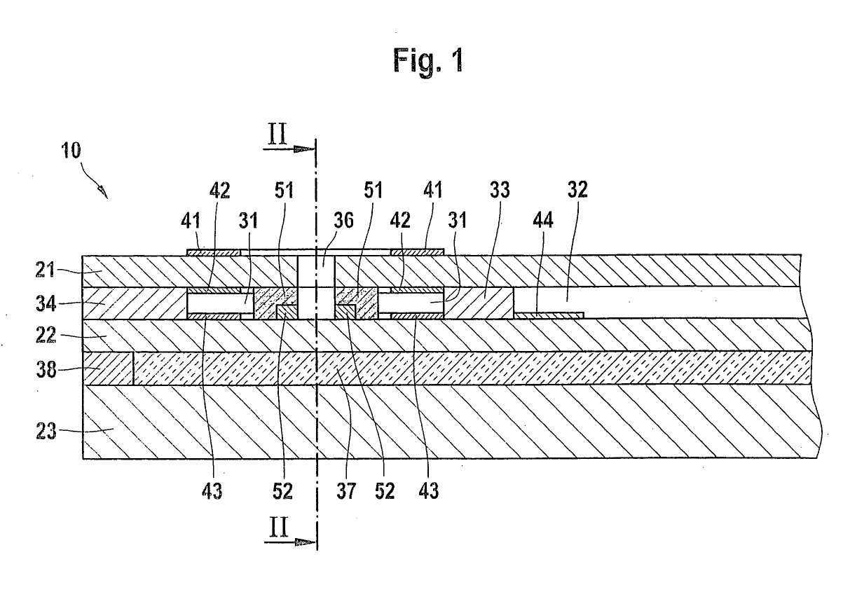

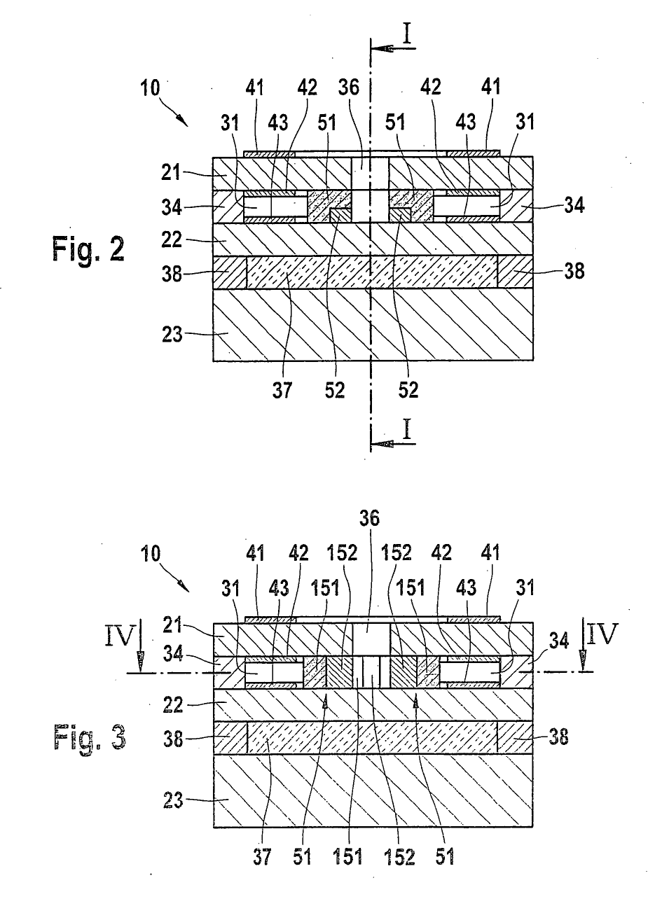

FIGS. 1 and 2 show a planar sensor element 10 which is configured in layers, situated in a housing in a gas-tight manner, and used for detecting the oxygen content in an exhaust gas of an internal combustion engine as the first exemplary embodiment of the present invention. FIG. 1 shows the section of sensor element 10 containing the measuring elements. The section of sensor element 10 not shown contains the supply region and the contact region, the configuration of which is known to those skilled in the art.

Sensor element 10 has a first, a second, and a third solid electrolyte layer 21, 22, 23. An annular measuring gas cavity 31 is introduced into sensor element 10 between first and second solid electrolyte layer 21, 22, a likewise annular and porous diffusion barrier 51 being provided in the center region of the measuring gas cavity. The measuring gas located outside sensor element 10 is able to travel via a gas entry opening 36, which is introduced into first solid electrolyte layer 21 and opens into the center of diffusion barrier 51, and through diffusion barrier 51 to reach measuring gas cavity 31. Measuring gas cavity 31 is laterally sealed by a sealing frame 34.

Moreover, a reference gas cavity 32, separated from measuring gas cavity 31 in a gas-tight manner by a separator 33 and extending in the direction of the longitudinal axis of sensor element 10, is provided between first and second solid electrolyte layer 21, 22. Reference gas cavity 32 contains a gas as a reference gas having a large oxygen content, ambient air for example.

A heating element 37 is provided between second and third solid electrolyte layers 22, 23, the heating element containing a printed conductor which is separated from surrounding solid electrolyte layers 22, 23 by an insulation. Heating element 37 is laterally surrounded by a heater frame 38 which electrically insulates and seals heating element 37 in a gas-tight manner.

An annular first electrode 41 is provided on the exterior surface of first solid electrolyte layer 21, gas entry opening 36 being situated in the center of the first electrode. In measuring gas cavity 31, an annular second electrode 42 is situated on the side of first solid electrolyte layer 21 opposite first electrode 41. A likewise annular third electrode 43 is situated on second solid electrolyte layer 22 in measuring gas cavity 31 (opposite second electrode 42). A fourth electrode 44 is provided on second solid electrolyte layer 22 in reference gas cavity 32.

First and second electrode 41, 42 and solid electrolyte 21, situated between first and second electrode 41, 42, form an electrochemical cell which is operated as a pump cell via a circuit situated outside of sensor element 10. Third and fourth electrode 43, 44 and solid electrolyte 22, situated between third and fourth electrode 43, 44, also form an electrochemical cell which is operated as a Nernst cell. The Nernst cell measures the oxygen partial pressure in the measuring gas cavity. The pump cell pumps oxygen into or out of the measuring gas cavity in such a way that an oxygen partial pressure of lambda=1 is present in the measuring gas cavity. Such sensor elements are known to those skilled in the art as broadband lambda probes.

Diffusion barrier 51 has an annular recess which extends radially in an outward direction from the inner lateral surface. The recess is approximately half as high as diffusion barrier 51. A gas-impermeable element 52 which is used for reducing the diffusion cross section in the region of the inner lateral surface of diffusion barrier 51 is provided in the recess. Element 52 is situated on the side of diffusion barrier 51 facing second solid electrolyte layer 22. However, the present invention is not dependent on the exact position of element 52. Element 52 may also be provided adjacent to first solid electrolyte layer 21, or element 52 may be situated in the center between first and second solid electrolyte layer 21, 22. Element 52 may also extend beyond the inner lateral surface of diffusion barrier 51 into gas entry opening 36 and may even have a cylindrical shape and may form the bottom of gas entry opening 36.

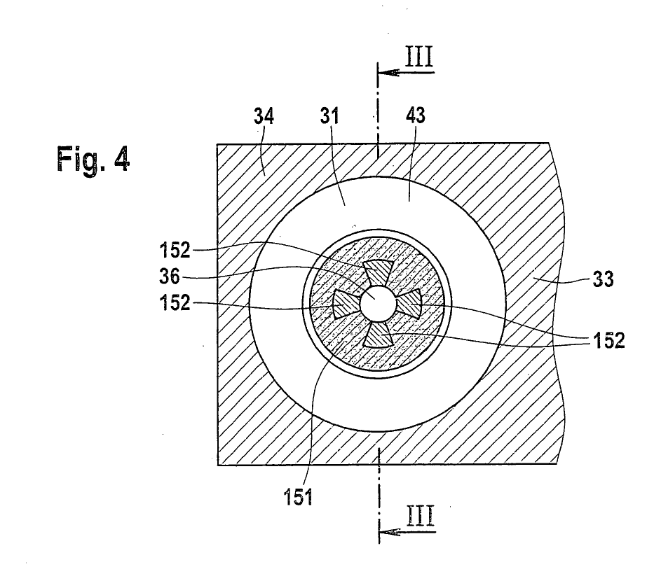

The second exemplary embodiment of the present invention shown in FIGS. 3 and 4 differs from the first exemplary embodiment in the design of the gas-impermeable element in the region of the inner lateral surface of diffusion barrier 51. Elements corresponding to one another are indicated in the first and second exemplary embodiments by the same reference numerals.

In the second exemplary embodiment, four evenly spaced arrow-like elements 152, which are gas-impermeable and thereby reduce the diffusion cross section on the side of diffusion barrier 151 facing away from second and third electrode 42, 43, are introduced into a diffusion barrier 151. Elements 152 extend over the entire height of diffusion barrier 151. Between elements 152, the measuring gas is able to travel through diffusion barrier 151 into measuring-gas cavity 31, thereby reaching second and third electrode 42, 43.

1.-8. (canceled)

9. A sensor element for determining a property of a measuring gas, comprising:
a solid electrolyte;
a diffusion barrier;
at least one electrode applied on the solid electrolyte and being in contact with the measuring gas via a diffusion path in which the diffusion barrier is situated; and
an arrangement, provided in a region of a side of the diffusion barrier facing away from the at least one electrode, for reducing a diffusion cross section in the region of the side of the diffusion barrier facing away from the at least one electrode.

10. The sensor element as recited in claim 9, wherein the sensor element determines a concentration of a gas component in the measuring gas.

11. The sensor element as recited in claim 9, wherein the arrangement at least one of has a smaller pore proportion than the diffusion barrier and is gas-impermeable.

12. The sensor element as recited in claim 9, wherein the diffusion barrier has one of a substantially cylindrical shape and a substantially hollow-cylindrical shape.

13. The sensor element as recited in claim 12, wherein:
the at least one electrode includes an annular shape and surrounds the diffusion barrier so that an exhaust gas is able to travel through a gas entry opening into an interior region of the diffusion barrier and from there via the diffusion barrier to reach the at least one electrode.

14. The sensor element as recited in claim 13, wherein the arrangement includes an annular element provided in at least one of a region of an interior lateral surface of the diffusion barrier and a region of the gas entry opening.

15. The sensor element as recited in claim 13, wherein the arrangement includes at least one arrow-like element provided in at least one of a region of an interior lateral surface of the diffusion barrier and a region of the gas entry opening.

16. The sensor element as recited in claim 15, wherein a height of the at least one arrow-like element corresponds to a height of the diffusion barrier.

17. The sensor element as recited in claim 12, wherein:
$$\frac{{A}_{1}}{{r}_{1}} > \frac{{A}_{2}}{{r}_{2}} ,$$
radii r₁ and r₂ relate to a center line of the diffusion barrier,
A₁ indicates the diffusion cross section at a distance r₁ from the center line of the diffusion barrier,
A₂ indicates the diffusion cross section at a distance r₂ from the center line of the diffusion barrier,
the arrangement reduces the diffusion cross section lying at distance r₂, but not distance r₁, from the center line of the diffusion barrier, and
r₁ is greater than r₂.
